(19) United States
(12) Patent Application Publication
(10) Pub. No.: US 2023/0225336 A1
(43) Pub. Date: Jul. 20, 2023

(54) DISCHARGE APPARATUS FOR FOOD MASSES INCLUDING A SIZE CONTROLLER

(71) Applicant: DIOSNA Dierks & Söhne GmbH, Osnabrück (DE)

(72) Inventor: Stefan BENSMANN, Osnabrück (DE)

(21) Appl. No.: 18/125,790

(22) Filed: Mar. 24, 2023

Related U.S. Application Data
(63) Continuation of application No. PCT/EP2021/075609, filed on Sep. 17, 2021.

(30) Foreign Application Priority Data
Sep. 25, 2020 (EP) 20198292.3

(51) Int. Cl. A21C 5/00; A21C 1/14; A21C 3/10

(52) U.S. Cl. CPC A21C 5/00; A21C 1/1445; A21C 3/10; A21C 1/1405

(57) ABSTRACT

A processing line for a food mass including a size controller to control a food mass discharged piece by piece from a kneading bowl. The size controller includes a space-fixed portion including parallel or substantially parallel separating strips with longitudinal axes extending in a first direction, and a punch movable between an upper position and a lower position and movable towards the separating strips and including a base plate to press pieces of the food mass on the separating strips against the separating strips and to comminute the food mass.

### CROSS REFERENCE TO RELATED APPLICATIONS

This application claims the benefit of priority to European Patent Application No. 20198292.3 filed on Sep. 25, 2020 and is a Continuation Application of PCT Application No. PCT/EP2021/075609 filed on Sep. 17, 2021. The entire contents of each application are hereby incorporated herein by reference.

### BACKGROUND OF THE INVENTION

### 1. Field of the Invention

The present invention relates to a processing line for a food mass, a lifting tipper with a discharge apparatus, a method for size controlling a food mass kneaded in a kneading bowl, and a method for discharging a food mass from a kneading bowl arranged in a lifting tipper.

### 2. Description of the Related Art

Products such as cookies, gingerbread, and bars, especially protein bars, chocolate bars, muesli bars, fruit bars, cereal bars, and the like, have a highly viscous food mass that entails special requirements during processing.

Mixing and kneading machines for such highly viscous food masses mainly consist of a mobile bowl of various sizes for masses from 120 kg to 1000 kg, into each of which a motor-driven mixing and kneading tool projects for carrying out the mixing and kneading process. After completion of the kneading process, the tool is retrieved, and the bowl is moved to a processing line. With the aid of a lifting tipper, the bowl is gripped by a lifting platform of the lifting tipper, brought to the height corresponding to the size of the lifting tipper and tilted by more than 90° so that the mass located in the bowl falls into the input station of a processing device arranged below it, which may be designed, for example, as a hopper. The processing device includes, for example, the rolling of the mass for layer-by-layer application on a conveyor belt, as is desired for multilayer products, in particular bars or cookies.

Highly viscous food masses are not flowable. During the kneading process, a large food mass block is formed. This is conventionally broken up manually or automatically by operating personnel when it is discharged from the lifting tipper, in order to provide individual smaller pieces of dough for further processing in the processing device. From the disclosure of WO 2020/094802 A1, it is also known to carry out the discharge fully automatically with the aid of a discharge device. In this case, there is a risk that the size of the discharged pieces is larger than the required maximum size. Pieces that are too large can partially or completely block the opening of the hopper of the processing device.

For the system to work reliably, it must be ensured that a maximum size of the pieces is not exceeded when the food mass is discharged from the kneading bowl. Until now, this has not been possible in an automated way.

### SUMMARY OF THE INVENTION

Preferred embodiments of the present invention provide processing lines for food masses each ensuring that maximum piece sizes are maintained in a fully automatic operation.

A food mass processing line according to a preferred embodiment of the present invention includes a size controller to control a size of food masses discharged one by one from a kneading bowl, the size controller including a space-fixed portion including parallel or substantially parallel separating strips with longitudinal axes extending in a first direction, and a punch movable between an upper position and a lower position and towards the separating strips, and including a base plate to press pieces of the food masses on the separating strips against the separating strips and to comminute the food masses.

Pieces of food masses that fall through the separating strips or are cut or separated by the separating strips and then fall through the separating strips have a size that is smaller than the maximum size. If pieces are too large and remain on the separating strips, the punch is used to press the pieces onto the separating strips so that these pieces are also cut into smaller pieces and fall through the separating strips. The size controller is operable to mechanically control the piece size and is particularly simple and robust.

The processing line preferably includes a lifting tipper with a discharger.

Preferably, the punch includes knives fixed to an underside of the base plate such that longitudinal axes of the knives extend along a second direction at an angle between about 80° and about 110° relative to the first direction. These knives can cut up large pieces extending parallel or substantially parallel to the separating strips. In order to make the comminuting effective, the knives of the movable punch are arranged one behind the other and spaced apart from each other along a common axis.

In order to ensure that all pieces fall through the separating strips, the space fixed portion of the size controller includes an inclined plane adjacent to the separating strips and defines a feeder of the food masses along the first direction onto the separating strips.

In order to further increase the cutting effect, the movable punch can preferably be vertically movable towards the separating strips, the knives of the punch being arranged in such a way that, in the lowest position of the punch, one blade in each case projects between two spaced separating strips.

It is advantageous if the base plate of the movable punch is held tiltably on an arm, the tilting axis being oriented perpendicular or substantially perpendicular to the first direction. The arm preferably includes a pneumatic cylinder.

The shortest distance between the separating strips preferably defines the maximum permissible size of the piecewise coherent food masses for processing.

Preferably, the size controller includes at least one sensor to detect pieces on the separating strips.

Preferably, the size controller includes, in the vertical direction below the separating strips, a hopper to feed the food mass into a processor, the size controller includes at least one sensor to detect pieces blocking the hopper.

The processing line particularly preferably includes a discharger to perform automated, batchwise discharge of a food mass from a kneading bowl arranged in a lifting tipper, which includes at least two cutting tools, which in turn each include at least two cutting edges, in order to cut through or cut up the food mass. The discharger is upstream of the size controller.

In addition, a method for size-controlling a food mass kneaded in a kneading bowl according to a preferred embodiment of the present invention includes discharging the kneaded food mass from the kneading bowl into pieces so that the pieces fall onto a size controller including spaced and parallel or substantially parallel separating strips positioned to allow a majority of the pieces to fall through the size controller, detecting that the pieces are on the separating strips, when it has been detected that the pieces are on the separating strips, moving a punch of the size controller from above towards the separating strips such that the pieces on the separating strips are pressed against the separating strips by a base plate of the punch and are comminuted.

Furthermore, a method for discharging a food mass from a kneading bowl arranged in a lifting tipper according to a preferred embodiment of the present invention includes tilting the kneading bowl about a tilting axis, introducing at least two cutting tools of a discharger on the lifting tipper into the kneading bowl, moving the at least two cutting tools relative to the food mass located in the kneading bowl such that the at least two cutting tools cut the food mass into smaller pieces, increasing the tilting angle of the kneading bowl such that the small pieces are discharged from the kneading bowl and the large pieces still present are retained, wherein the discharged pieces fall onto or through mutually spaced and parallel separating strips of a size controller, the method further includes detecting that pieces are on the separating strips, moving a punch of the size controller from above towards the separating strips such that the pieces are pressed against the separating strips by a base plate of the punch and are comminuted.

Provision may be made for the pieces to fall from the kneading bowl directly onto the separating strips, or an inclined plane or conveyor belt or the like may be used to feed the size controller.

The size controller is formed as mentioned above.

Preferably, the size controller includes a hopper below the separating strips which feeds the pieces to a processor, and the method includes detecting that the hopper is clogged with pieces of the food mass and stopping the discharge of the food mass from the kneading bowl arranged in the lifting tipper.

The discharger is stopped when the hopper is clogged, and the pieces can be manually removed from the hopper so that the line can then start up again without any problems.

As already explained above, it is advantageous if the base plate of the movable punch is held tiltably on a cylinder rod of the punch, the tilting axis being oriented perpendicular or substantially perpendicular to the direction of travel of the punch and to the longitudinal axes of the cut-off lines.

The above and other elements, features, steps, characteristics and advantages of the present invention will become more apparent from the following detailed description of the preferred embodiments with reference to the attached drawings.

### BRIEF DESCRIPTION OF THE DRAWINGS

Preferred embodiments of the present invention are explained in more detail below with reference to the drawings. Similar or similarly acting components are designated in the figures with the same reference signs.

FIG. 1 shows a schematic representation of a lifting tipper with discharge device in different positions from the prior art.

FIG. 2 shows a side view of the discharge device of FIG. 1 with a size control device placed next to it.

FIG. 3 shows a top view of the size control device of FIG. 2.

FIG. 4 shows a view into the interior of the size control device.

FIG. 5 shows a side view of the size control device.

### DETAILED DESCRIPTION OF THE PREFERRED EMBODIMENTS

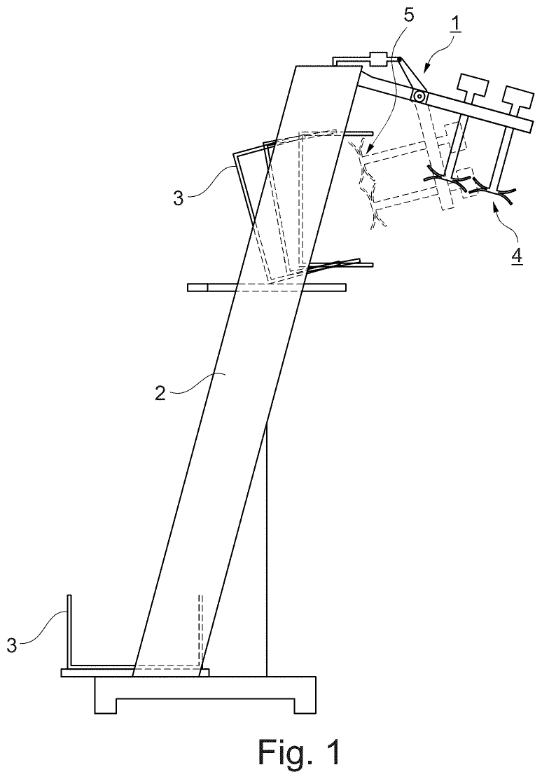

FIG. 1 shows an automatic discharge device 1 mounted on a lifting tipper 2 of a dough processing line. In the following, the processing of a highly viscous food dough is described. However, the discharge device is also suitable for processing highly viscous bar or stick masses, which is carried out analogously to dough processing.

A dough mixing and kneading machine, which is not shown, is connected upstream of the hoisting tipper 2 in the production flow. This dough mixing and kneading machine includes a bowl in which the dough is formed by a motor-driven mixing and kneading tool. After completion of the kneading process, the bowl is moved to the lifting tipper 2. FIG. 1 illustrates the lifting tipping process of the lifting tipper. First, a bowl 3 is lifted in the lifting tipper 2 and then tilted. A discharge device 1 with rotating cutting tools is swiveled into the bowl 3 during the tilting process so that the cutting tools 4 are fed to the dough located in the bowl 3. Due to a relative movement of the dough to the cutter heads 5 of the cutting tools, the dough is moved past them and cut, peeled off and/or separated by means of the cutting edges. The dough block is thus continuously reduced in size. The separated dough mass first remains in the bowl 3 and, as soon as the tipping angle is large enough, falls onto a conveyor unit not shown below the bowl, which transports the dough mass to a device for size control.

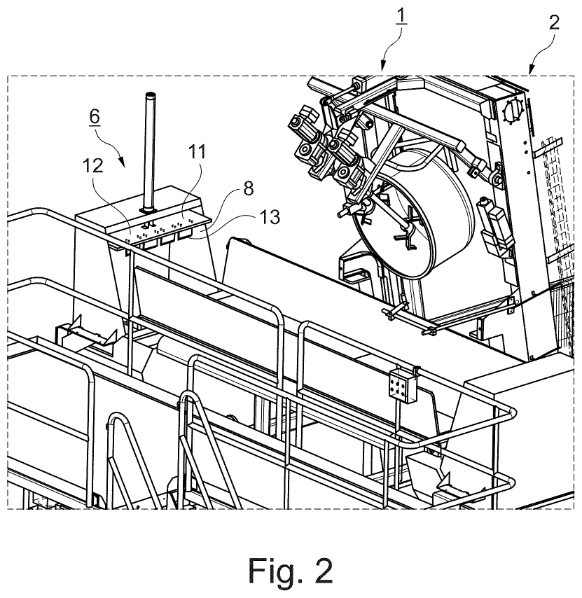

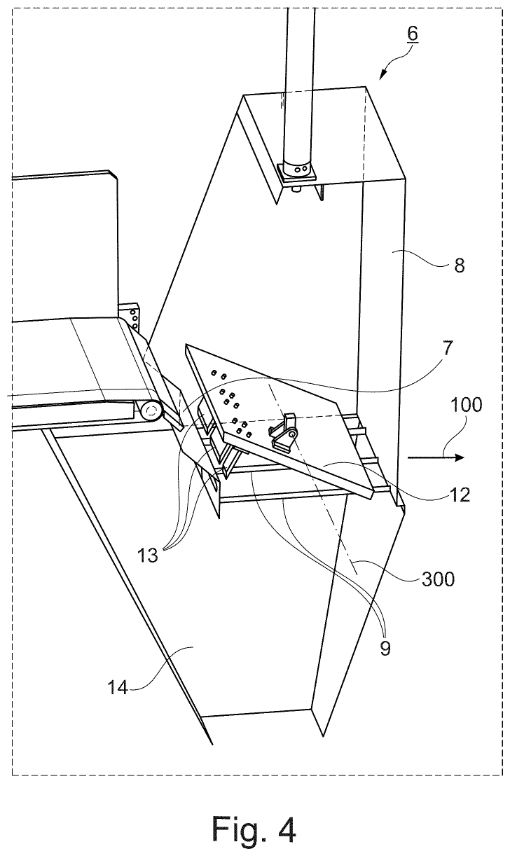

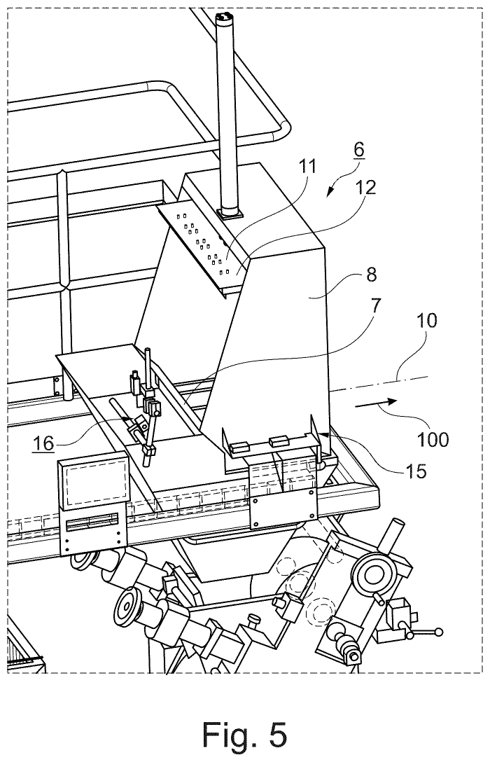

FIGS. 2 to 5 show a device for size control 6 of the dough masses discharged from the discharge device 1. This device 6 is connected downstream of the lifting tipper 2 and the discharge device 1 during the processing of the dough. The size control device 6 has, shown in FIGS. 4 and 5, an inclined plane 7 which is inclined in a first direction 100 and onto which the dough masses discharged from the kneading bowl fall. Adjacent to the inclined plane 7 is a space enclosed by outer sides 8, in which four separating strips 9 are arranged. The separating strips 9 are elongated metal plates, which in the front area (adjacent to the inclined plane) are designed as knife blades, the sharp blade of which is located at the top in the vertical direction, and which in the rear area are designed with a blunt contact surface. The separating strips 9 are oriented with their longitudinal axes 10 along the first direction 100 and are evenly spaced from each other and from the outer sides 8 of the device. If the dough mass is small enough, it can pass through the space between the separating strips 9. Larger pieces fall onto the separating strips 9 and are crushed or cut by the separating strips 9 or remain on the separating strips 9.

The size control device 6 further includes a movable punch 11 having a base plate 12, the size of the base plate 12 corresponding to the size of the enclosed space. The punch 11 can be advanced towards the separating strips 9 in a vertical direction, so that pieces lying on the separating strips 9 can be pressed against the separating strips 9 by the punch 11, causing the pieces to be comminuted or cut by the separating strips 9 and to fall through downwardly. Knives 13 are arranged on the underside of the base plate of the punch 12, extending vertically from the underside. The knives 13 lie one behind the other on a common axis 200, the axis 200 being oriented perpendicular or substantially perpendicular to the first direction 100. The knives 13 are identically formed. In the example shown, there are four knives. The punch 11 moves in a vertical direction between an uppermost position and a lowermost position. In the uppermost position, the space above the separating strips 9 is free for the discharged food pieces. In the lowest position, the base plate 12 rests on the separating strips 9, in particular in the rear, blunt area. In the lowest position, the knives 13 of the punch each protrude through two adjacent separating strips 9 or between a separating strip 9 and an outer wall of the device. The base plate 12 is tiltably held in a tilting joint on a cylinder rod. The tilting axis 300 is perpendicular or substantially perpendicular to the first direction 100 and parallel or substantially parallel to the axis 200. If the base plate 12 encounters pieces lying on the separating strips 9 in the front area, on one side of the tilting axis 300, the base plate 12 tilts until it encounters the separating strips 9 with an outer side on the other side of the tilting axis 300. The punch is then moved further down in the axial direction and a tilting of the base plate 12 is produced, so that an additional cutting effect is produced. The punch thus not only presses the food pieces through the separating strips, but the pieces are also cut by the knives 13.

Below the separating strips 9, the size control device 6 includes a hopper 14 that feeds the pieces falling through the separating strips 9 to a processing section below.

The size control device 6 is sensor-monitored. A first sensor unit 15 is used to control an area above the separating strips 9. The punch 11 is only moved for a pressing/cutting process if the first sensor unit 15 detects pieces of food mass lying on the separating strips 9.

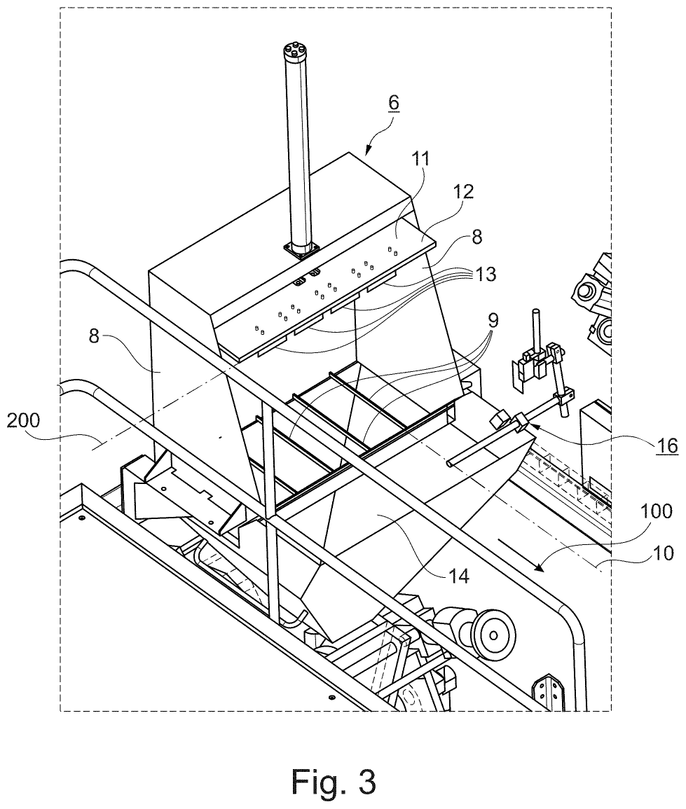

A second sensor unit 16 monitors the hopper space enclosed by the hopper 14. FIGS. 3 and 5 show the second sensor unit. If the hopper 14 becomes clogged or blocked by pieces that are too large, this is detected by the second sensor unit 16, and the discharge device and preferably also the processing device located below and fed by the hopper are stopped.

By using the size control device 6 as described above, it can be prevented that too large food mass lumps are discharged which would clog the processing device. Continuous feeding of the batch in the bowl 3 into the processing device is possible.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A food mass processing line comprising:
a size controller to control a size of food masses discharged one by one from a kneading bowl; wherein
the size controller includes:
a space-fixed portion including parallel or substantially parallel separating strips with longitudinal axes extending in a first direction; and
a punch movable between an upper position and a lower position and towards the separating strips, and including a base plate to press pieces of the food masses on the separating strips against the separating strips and to comminute the food masses.

2. The processing line according to claim 1, wherein knives are fixed to an underside of the base plate such that longitudinal axes of the knives extend along a second direction at an angle between about 80° and about 110° relative to the first direction.

3. The processing line according to claim 2, wherein the knives are arranged one behind the other and spaced apart from each other along on a common axis.

4. The processing line according to claim 1, wherein the space-fixed portion of the size controller includes an inclined plane adjacent to the separating strips and defining a feeder of the food masses along the first direction onto the separating strips.

5. The processing line according to claim 2, wherein the punch is vertically movable towards the separating strips in order to comminute pieces of the food masses on the separating strips, and the knives are arranged such that in a lowermost position of the punch, one of the knives projects between two of the separating strips.

6. The processing line according to claim 1, wherein the base plate is tiltably held on a cylinder rod via a tilting axis perpendicular or substantially perpendicular to the first direction.

7. The processing line according to claim 1, wherein a shortest distance between the separating strips defines a maximum permissible size of the food masses.

8. The processing line according to claim 1, wherein the size controller includes a sensor to detect pieces of the food masses on the separating strips.

9. The processing line according to claim 1, wherein the size controller includes a hopper vertically below the separating strips to feed the food masses into a processor, the size controller including at least one sensor to detect pieces of the food masses blocking the hopper.

10. The processing line according to claim 1, further comprising a discharger to perform automated, portion-by-portion discharge of the food masses from a kneading bowl in a lifting tipper, which includes at least two cutting tools each including at least two cutting edges to cut through or cut up the food masses and which is connected upstream of the size controller.

11. A method for size-controlling a food mass kneaded in a kneading bowl, the method comprising:
a) discharging the kneaded food mass from the kneading bowl into pieces so that the pieces fall onto a size controller including spaced and parallel or substantially parallel separating strips positioned to allow a majority of the pieces to fall through the size controller;
b) detecting that the pieces are on the separating strips; and
c) when it has been detected that the pieces are on the separating strips, moving a punch of the size controller from above towards the separating strips such that the pieces on the separating strips are pressed against the separating strips by a base plate of the punch and are comminuted.

12. A method for discharging a food mass from a kneading bowl in a lifting tipper, the method comprising:
tilting the kneading bowl about a tilting axis;
introducing at least two cutting tools of a discharger on the lifting tipper into the kneading bowl;
moving the at least two cutting tools relative to the food mass located in the kneading bowl such that the at least two cutting tools cut the food mass into smaller pieces;
increasing the tilting angle of the kneading bowl such that the small pieces are discharged from the kneading bowl and the large pieces still present are retained; wherein
the discharged pieces fall onto or through mutually spaced and parallel separating strips of a size controller;
the method further comprising:
detecting that pieces are on the separating strips; and
moving a punch of the size controller from above towards the separating strips such that the pieces are pressed against the separating strips by a base plate of the punch and are comminuted.

13. The method according to claim 12, wherein the punch carries knives on an underside of the base plate which, when the punch is moved towards the separating strips, engage between the separating strips and comminute pieces of the food mass thereon.

14. The method according to claim 12, wherein the size controller includes, below the separating strips, a hopper to feed the pieces of the food mass to a processor, and the method further comprises:
detecting that the hopper is clogged with the pieces and stopping the discharge of the food mass from the kneading bowl.

15. The processing line according to claim 1, wherein the base plate is tiltably held on a cylinder rod of the punch at a tilting axis perpendicular or substantially perpendicular to a direction of travel of the punch.
